(19) United States
(12) Patent Application Publication
(10) Pub. No.: US 2009/0321151 A1
(43) Pub. Date: Dec. 31, 2009

(54) TRACK SYSTEM WITH ADJUSTABLE WIDTH

(76) Inventors: RENE ARCHAMBAULT, ST-HYACINTHE (CA); ROBERT BESSETTE, ST-CHARLES-DE-DRUMMOND (CA); GUILLAUME PROVENCHER, ST-GERMAIN-DE-GRANTHAM (CA); JONATHAN THIBAULT, MONT ST-HILAIRE (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/493,485

(22) Filed: Jun. 29, 2009

Related U.S. Application Data
(60) Provisional application No. 61/076,531, filed on Jun. 27, 2008.

(51) Int. Cl. B62D 55/084; F16H 55/30

(52) U.S. Cl. 180/9.21; 474/152

(57) ABSTRACT

This invention generally relates to track systems and traction assemblies for use as wheel replacement for wheeled vehicles. The track system uses a traction band disposed about a sprocket wheel, idler wheels and a road wheels for propulsion. The idler wheels and road wheels are typically pivotally mounted to a support frame, itself configured to be movably coupled to the vehicle frame via a support member. The track system can be adjustably spaced from the vehicle frame by selectively inserting one or more spacing elements between the sprocket wheel and the axle.

### CROSS-REFERENCE TO RELATED APPLICATIONS

The present patent application claims the benefits of priority of U.S. Provisional Patent Application No. 61/076,531, entitled “Adjustable Width Track System” and filed at the United States Patent and Trademark Office on Jun. 27, 2009, the content of which is incorporated herein by reference.

### FIELD OF THE INVENTION

The present invention generally relates to track systems and traction assemblies used as wheel replacement for typically wheeled vehicles. More particularly, the present invention relates to track systems and traction assemblies for use on heavy vehicles such as, but not limited to, farming and agricultural vehicles (e.g. tractors, harvesters, etc.) and construction and industrial vehicles (e.g. excavators, combines, forestry equipments).

### BACKGROUND OF THE INVENTION

Soil compaction and flotation have always been important issues for farmers operating tractors and other farming vehicles in their fields. Having a tractor equipped with track systems assures lower ground pressure, better traction and better use of the available power. This is particularly important in row-crop production where the width of the track is required to be as thin as possible to maximize the production. Rolling with thin tires affects the ground pressure which validates the need for tracks.

However, the row-crop industry is not managed by standards. Each farmer typically chooses his row width which may vary even within some of his fields. To help these farmers with a track-based solution, custom track systems are typically required for each width required by the farmers. Custom track systems are however inherently costly.

Solutions have been proposed to provide width adjustability to track systems. However, these track systems are typically complex, difficult to repair and hard to steer and operate.

Hence, despite ongoing development in the field of track systems, there is still a need for a novel track system which mitigates the drawbacks of prior track systems while still providing the ability to select the width thereof.

### SUMMARY OF THE INVENTION

The present invention therefore provides a solution to the shortcomings of the prior art by providing a novel track system which can be adjustably and selectively spaced from the vehicle frame to which it is mounted.

In accordance with the principles of the present invention, the track system generally comprises a sprocket wheel configured to be mounted to one of the wheel axles of the vehicle, a support frame movably coupled to the frame of the vehicle via a support member preferably mounted near the wheel axle, and generally independently of the sprocket wheel, and a longitudinally extending endless traction band mounted thereabout. The support frame typically pivotally supports wheels such as idlers wheels mounted at the fore and at the aft, and road wheels mounted along the length thereof.

In accordance with the present invention, the track system is further provided with at least one and preferably a plurality of spacing elements, typically embodied as spacer rings or segments, each having a predetermined thickness. The spacing elements are mounted in cooperation with the sprocket wheel and can be selectively mounted on the inner side or on the outer side thereof. The spacing elements mounted on the inner side of the sprocket wheel become effectively lodged between the sprocket wheel and the wheel axle and space the sprocket wheel, and thus the track system, from the vehicle frame. By selecting a particular combination of spacing elements to be mounted between the sprocket wheel and the wheel axle, the space between the sprocket wheel and the vehicle frame, and thus the effective width of the track system can be changed.

Similarly, the support frame is pivotally mounted to the support member via a laterally extending rod to which are also mounted corresponding spacing elements, preferably embodied as spacer rings or segments. Though generally smaller in diameter than the spacing elements of the sprocket wheels, the spacing elements of the support frame are preferably provided in same number with same thickness to provide corresponding spacing.

As for the spacing elements of the sprocket wheel, the spacing elements of the support frame can be selectively mounted on the inner side or on the outer side of the support frame.

Preferably, symmetric track systems are respectively mounted on each side of the vehicle. Thus, by selectively adjusting the space between each sprocket wheel and the vehicle frame, and between the support frame and support member, the overall width of the vehicle can be selectively adjusted using simple spacing elements.

In accordance with the present invention, the spacing elements can be provided in different numbers and/or in different thicknesses depending on the size and configuration of the track systems and depending on the required precision of the spacing. Still, by selectively combining the spacing elements of the sprocket wheel and of the support frame, many spacing configurations can be achieved. Hence, the track system of the present invention can achieve different over width configurations without the need for custom pieces.

Though the present invention is particularly useful for track systems used on farming and generally agricultural vehicles, the present invention could also be used in the grooming industry for adaptation to the track sizes, or in the construction industry as an adjustment for added stability or increased manoeuvrability in small areas.

Understandably, other advantages and novel features of the present invention will be obvious upon an understanding of the illustrative embodiments about to be described by reference to the following detailed description and considered in connection with the accompanying drawings in which like reference symbols designated like elements throughout the figures.

### BRIEF DESCRIPTION OF THE DRAWINGS

The above and other objects, features and advantages of the invention will become more readily apparent from the following description, reference being made to the accompanying drawings in which:

FIG. 1 is a cross-section view of an exemplary track system in accordance with the present invention, in a retracted position, without an endless traction band, and as mounted to the rear axle of a vehicle.

FIG. 2 is a cross-section view of the track system of FIG. 1, in extended position, without an endless traction band, and as mounted to the rear axle a vehicle.

FIG. 3 is a perspective view of the track system illustrated in FIG. 1.

FIG. 4 is a perspective view of the track system illustrated in FIG. 2.

FIG. 5 is a perspective view of the track system of FIG. 2, with an endless traction band mounted thereon.

### DETAILED DESCRIPTION OF THE PREFERRED EMBODIMENT

A novel track system will be described hereinafter. Although the invention is described in terms of specific illustrative embodiments, it is to be understood that the embodiments described herein are by way of example only and that the scope of the invention is not intended to be limited thereby.

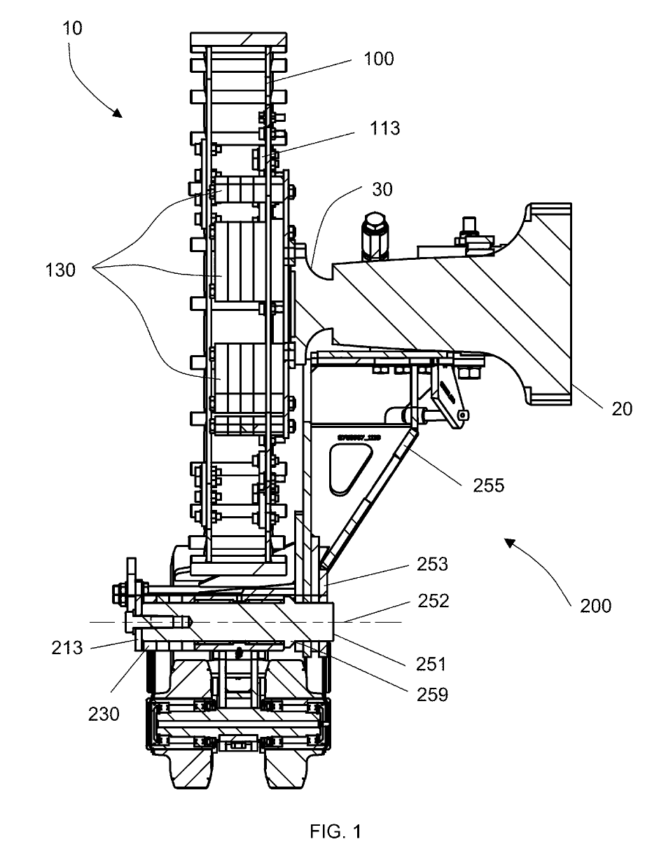

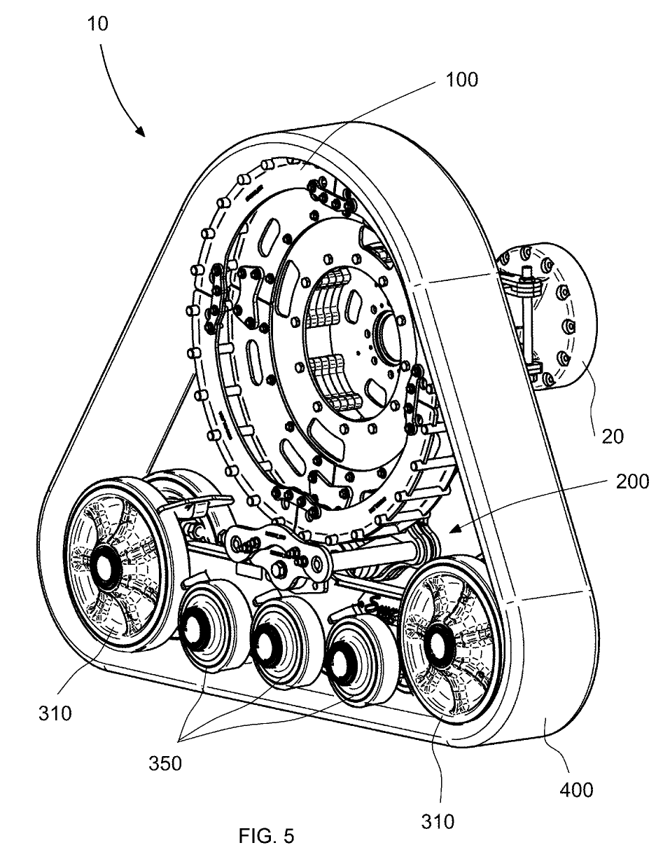

The present invention will be illustrated using an exemplary track system generally illustrated in FIGS. 1 to 5. Though not shown, the track system of the present invention is typically used in pair wherein symmetrical track systems are mounted to the wheel axle on each side of the vehicle.

Referring now to FIGS. 1 to 5, the track system 10 will be described in more details.

The track system 10 typically comprises a sprocket wheel 100 adapted to be mounted to the wheel axle 30 (or wheel hub) of a vehicle (not shown). The track system 10 also comprises a support structure 200 mounted to the frame 20 of the vehicle. The support structure 200 is generally provided with wheels 300 such as idler wheels 310 pivotally mounted at the fore or front portion thereof and at the aft or rear portion thereof, and road wheels 350 pivotally mounted along the length thereof. Disposed around the sprocket wheel 100, the support structure 200, and wheels 300 is a longitudinally extending endless traction band 400 preferably made of reinforced elastomeric material.

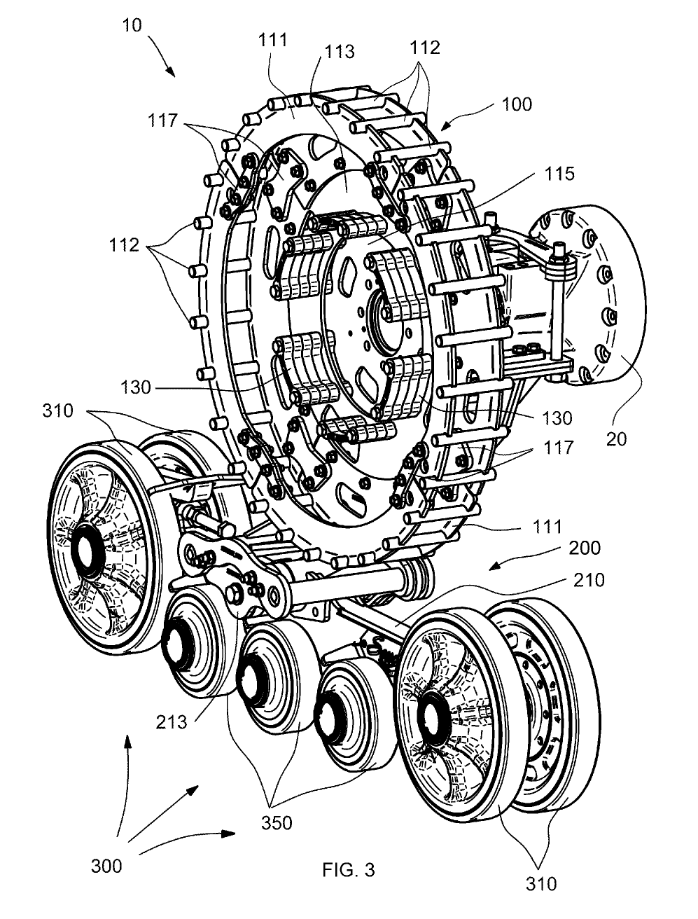

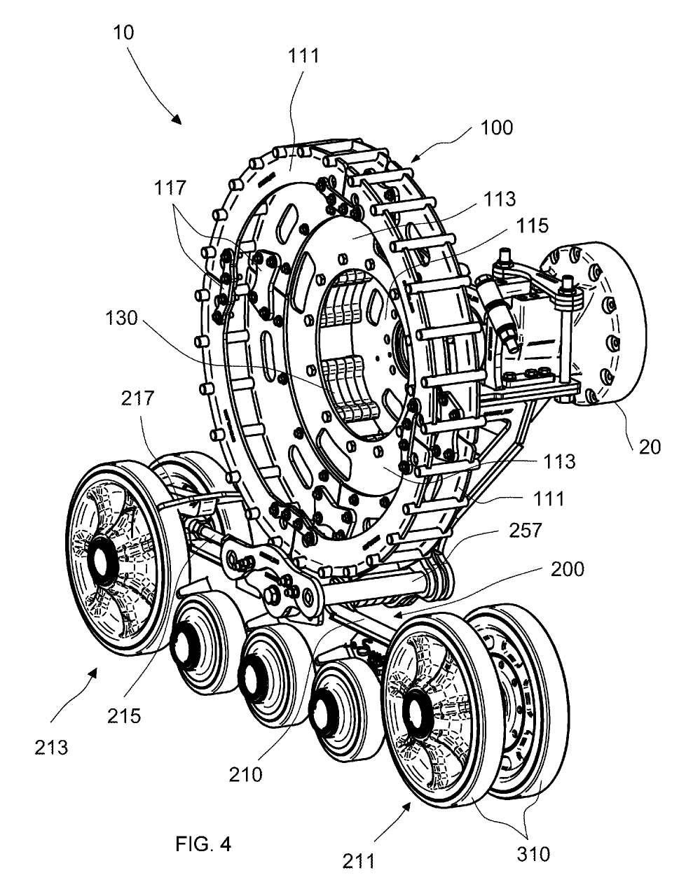

Referring now to FIGS. 3 and 4, the sprocket wheel 100 of the track system 10 is illustrated in more details. The sprocket wheel 100 generally comprises a plurality of generally evenly spaced and axially extending sprocket teeth 112 located at the periphery thereof. The sprocket teeth 112 are configured to drivingly engage drive lugs (not shown) longitudinally disposed on the inner surface of the traction band 400.

As shown in FIGS. 3 and 4, the sprocket wheel 110 is preferably composed of several (e.g. four (4) in the present embodiment) arcuate peripheral sprocket portions 111, a support ring 113, and a central disk 115.

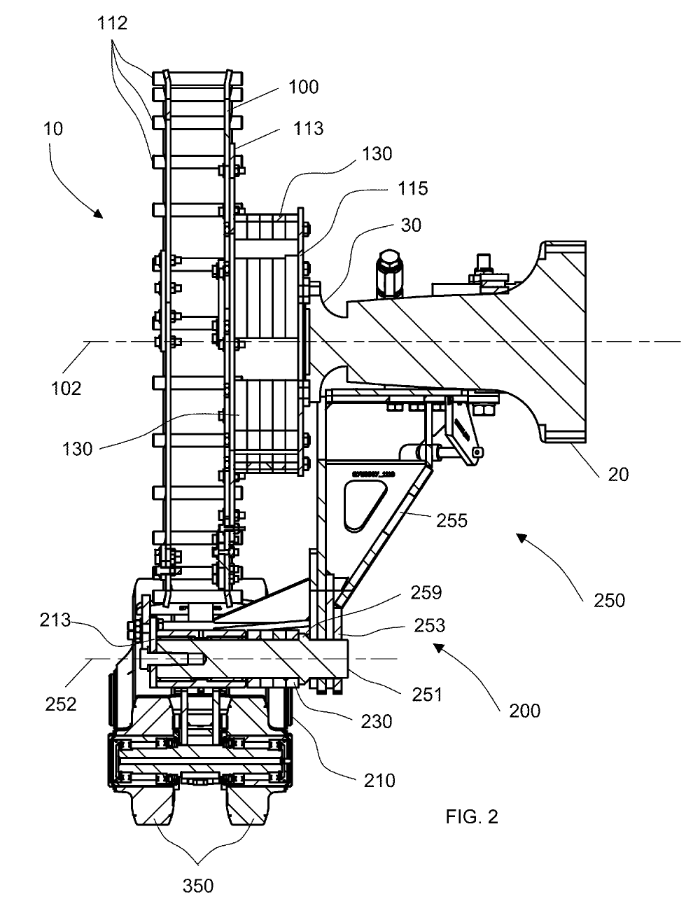

As depicted in FIGS. 1 and 2, the central disk 115 of the sprocket wheel 100 is configured to be mounted on the axle 30 (or wheel hub, not shown) of the vehicle with fasteners known in the art. The central disk 115 is provided, at its outer periphery, with openings configured to receive fasteners.

Mounted to the outer periphery of the central disk 115 is the support ring 113. The support ring 113 is typically secured to the central disk 115 with fasteners such as nuts and bolts assemblies.

For their parts, the peripheral portions 111 are mounted at the outer periphery of the support ring 113 using fasteners such as nuts and bolts assemblies. As best illustrated in FIG. 3, consecutive peripheral portions 111 are typically further secured together via attaching plates 117 and fasteners such nuts and bolts assemblies.

As this point, the skilled addressee will understand that the sprocket wheel 100 illustrated in the figures is a preferred embodiment. In fact, even though the central disk 115 and the support ring 113 have been shown as unitary components, and the peripheral portions 111 as split components, different sprocket wheel configurations could allow for a unitary peripheral portion 111 and/or for a split central disk 115 and/or a split support ring 113. Moreover, the peripheral sprocket portion(s) 111 and the support ring 113 could also be unitary. The present invention is understandably not so limited.

Referring now to FIGS. 1 to 4, in order to provide width adjustability to the track system 10, the sprocket wheel 100 is provided with spacing elements 130. The spacing elements 130 are generally embodied as rings or arcuate segments having predetermined thicknesses. As best shown in FIGS. 1 and 2, the spacing elements 130 are configured to be mounted on an outer side and/or an inner side of the support ring 113.

In FIG. 1, all the spacing elements 130 are mounted on the outer side of the support ring 113 and the sprocket wheel 100 is correspondingly closer to the vehicle frame 20. In FIG. 2, all the spacing elements 130 are mounted on the inner side of the support ring 113 and the sprocket wheel 100 is correspondingly spaced away from the vehicle frame 20. As the skilled addressee will understand, and as best illustrated in FIGS. 2 and 4, when spacing elements 130 are mounted on the inner side of the support ring 113, they become effectively lodged between the support ring 113 and the central disk 115.

The added thickness caused by the spacing elements 130 located between the support ring 113 and the central disk 115 effectively pushes the track system 10 further away from the vehicle frame 20, effectively changing the overall width of the track system 10.

Notably, though in FIGS. 1 and 2, the spacing elements 130 are either all located on the outer side of the support ring 113 (FIG. 1) or on the inner side thereof (FIG. 2), it is to be understood that only a subset of the spacing elements 130 could be mounted between the support ring 113 and the central disk 115, the remaining spacing elements 130 being left mounted on the outer side of the support ring 113 for possible future use. Hence, depending on the required width of the track system 10, the required number of spacing elements 130 mounted between the support ring 113 and the central disk 115 could vary.

In addition, even though the spacing elements 130 shown in FIGS. 1 and 2 are all of similar thickness, spacing elements 130 having different thicknesses are possible. In that sense, set of spacing elements 130 having different thicknesses could be provided with the track system for providing several width configurations. The user would then select only the spacing elements 130 providing the desired spacing.

Referring back to FIGS. 3 and 4, the support structure 200 of the track system 10 will be described in more details.

Support structure 200 typically comprises a support frame 210 pivotally mounted to a support member 250, the support member 250 being fixedly mounted to the frame 20 of the vehicle via conventional brackets and fasteners.

As best depicted in FIGS. 3 and 4, the support frame 210 is preferably longitudinally extending and pivotally supports idler wheels 310 at its fore portion 211 and aft portion 213, and road wheels 350 along its length. The support frame 210 is preferably further provided with tensioning mechanism 215 such as a conventional push-bolt tensioner for adjusting the tension of the traction band 400 through the front or rear idler wheels 310. The support frame 210 is also advantageously provided with scraping blades 217 for removing debris lodged on and/or between the idler wheels 350.

For its part, and as shown in FIGS. 1 and 2, the support member 250 is typically composed of a lower portion 253 typically located underneath the sprocket wheel 100, and an upper portion 255 configured to be fixedly mounted to the vehicle frame 20.

As best illustrated in FIGS. 1 and 2, the support frame 210 is pivotally coupled to the lower portion 253 of the support member 250 through a laterally extending rod 251 fixed to the lower portion 253. Notably, the axis of rotation 252 of the support frame 210 with respect to the rod 251 is located lower than the axis of rotation 102 of the sprocket wheel 100, allowing the support frame 210 to pivot independently of the sprocket wheel 100.

Referring now to FIGS. 3 and 4, the lower portion 253 of the support member 250 is advantageously provided with laterally extending blocking rods 257 located before and behind the rod 251. These blocking rods 257 are configured to prevent excessive rotation of the support frame 210 with respect to the rod 251. In case of excessive rotation, the support frame 210 will abut on either one of the blocking rods 257 and damages to the sprocket wheel 100 will be prevented.

Referring back to FIGS. 1 and 2, the support frame 210 is also slidingly mounted to the rod 251. Indeed, since the sprocket wheel 100 can be more or less spaced from the frame 20 of the vehicle via the use of spacing elements 130, and since the traction band 400 is disposed around both the sprocket wheel 100 and the support frame 210, the support frame 210 must be laterally displaceable along rod 251 to remain aligned with the sprocket wheel 100. However, to prevent unwanted movements of the support frame 210 along the rod 251, spacing elements 230 are disposed on the inner side (FIG. 2) and/or the outer side (FIG. 1) of the support frame 210.

Spacing elements 230 are preferably embodied as spacer rings. Spacing elements 230 are preferably slidingly mounted to the rod 251 and are lodged, on the inner side, between the support frame 210 and a shoulder 259 formed in rod 251, and on the outer side, between the support frame 210 and a side plate 213 fixed to rod 251 by a bolt.

The skilled addressee will understand that the spacing defined by the combination of spacing elements 130 mounted between the support ring 113 and the central disk 115 should be equal to the spacing defined by the combination of spacing elements 230 mounted between the support frame 210 and the support member 250 in order to keep the traction band 400 aligned.

It is to be noted that the spacing elements 130 and 230 may be provided in a plurality of thickness. It is thus possible to use one set of spacing elements 130 and 230 having the desired dimensions or to use a combination of spacing elements 130 and 230 giving the same desired dimensions. For example, to space the track system 10 about four inches on one side of the vehicle, a user could use a spacing element 130 four inches thick and two spacing elements 230 two inches thick, or even four pairs of spacing elements 130 and 230 one inch thick. Other combinations are understandably possible.

Typically, but not necessarily, track systems 10 mounted on each side of a vehicle will be spaced symmetrically. Still, a track system 10 mounted on one side could be spaced differently then the opposite track system 10 mounted on the other side if necessary or practical. The present invention allows such possibilities.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A track system configured to be mounted to an axle of a vehicle having a frame, said track system comprising:
a) a sprocket wheel adapted to be mounted to said axle;
b) a support structure comprising a support member adapted to be mounted to said vehicle frame and a support frame pivotally mounted to said support member;
c) wheels pivotally mounted to said support frame;
d) a traction band disposed around said sprocket wheel, said support frame and said wheels;
e) first spacing elements configured to be removably mounted between said sprocket wheel and said axle for spacing said sprocket wheel from said vehicle frame;
f) second spacing elements configured to be removably mounted between said support frame and said support member for spacing said support frame from said support member.

2) A track system as claimed in claim 1, wherein said sprocket wheel comprises a central disk portion configured to be mounted to said axle, and a peripheral portion configured to be mounted to said central disk portion, and wherein said first spacing elements are configured to be removably mounted between said peripheral portion and said central disk portion.

3) A track system as claimed in claim 2, wherein said peripheral portion comprising a support ring portion and a sprocket peripheral portion.

4) A track system as claimed in claim 3, wherein said sprocket peripheral portion comprises a plurality of portions.

5) A track system as claimed in claim 1, wherein said first spacing elements are rings having predetermined thicknesses.

6) A track system as claimed in claim 1, wherein said first spacing elements are arcuate segments having predetermined thicknesses.

7) A track system as claimed in claim 1, wherein said second spacing elements are rings having predetermined thicknesses.

8) A track system as claimed in claim 1, wherein said support member comprises an upper portion configured to be mounted to said vehicle frame, and a lower portion depending from said upper portion and having a laterally extending rod.

9) A track system as claimed in claim 8, wherein said support frame is pivotally mounted to said rod.

10) A track system as claimed in claim 9, wherein said second spacing elements are configured to be removably mounted on said rod between said support frame and said lower portion of said support member.

11) A track system as claimed in claim 9, wherein said rod further defines a shoulder and wherein said second spacing elements are configured to be removably mounted on said rod between said support frame and said shoulder.

12) A track system as claimed in claim 1, wherein a first spacing defined by said first spacing elements selectively mounted between said sprocket wheel and said axle is substantially equal to a second spacing defined by said second spacing elements selectively mounted between said support frame and said support member.

13) A track system comprising:
a) a sprocket wheel comprising a central portion, a peripheral portion, and first spacing elements selectively mountable between said peripheral portion and said central portion for selectively spacing said peripheral portion from said central portion;
b) a support structure comprising a support member, a support frame pivotally thereto, and second spacing elements selectively mountable between said support frame and said support member for selectively spacing said support frame from said support member;
c) wheels pivotally mounted to said support frame.

14) A track system as claimed in claim 13, further comprising a traction band disposed around said sprocket wheel, said support frame and said wheels.

15) A track system as claimed in claim 13, wherein said first spacing elements are rings having predetermined thicknesses.

16) A track system as claimed in claim 13, wherein said first spacing elements are arcuate segments having predetermined thicknesses.

17) A track system as claimed in claim 13, wherein said second spacing elements are rings having predetermined thicknesses.

18) A track system as claimed in claim 13, wherein a first spacing defined by said first spacing elements selectively mounted between said peripheral portion and said central portion is substantially equal to a second spacing defined by said second spacing elements selectively mounted between said support frame and said support member.

19) A sprocket wheel for use in combination with a track system, said sprocket wheel comprising a central portion, a peripheral portion configured to be mounted to said central portion, and first spacing elements selectively mountable between said peripheral portion and said central portion for selectively spacing said peripheral portion from said central portion.

20) A sprocket wheel as claimed in claim 19, wherein said peripheral portion comprises a support ring portion and a sprocket peripheral portion.

21) A sprocket wheel as claimed in claim 20, wherein said sprocket peripheral portion comprises a plurality of portions.
